(19) United States
(12) Patent Application Publication
(10) Pub. No.: US 2006/0149724 A1
(43) Pub. Date: Jul. 6, 2006

(54) Methods relating to data repository querying

(76) Inventors: Gerd M. Ritter, Heidelberg (DE); Winfried Schleier, Theilenhofen (DE)

Correspondence Address: FISH & RICHARDSON, P.C., PO BOX 1022, MINNEAPOLIS, MN, 55440-1022, US

(21) Appl. No.: 11/027,196

(22) Filed: Jan. 3, 2005

(51) Int. Cl. G06F 17/30

(52) U.S. Cl. 707/4

(57) ABSTRACT

A method to be performed before performing a data repository query includes receiving an input from a user, the input specifying a query to be performed in a data repository. Before performing the query, it is determined whether the query meets a predefined criterion associated with slow data repository queries. If the query meets the predefined criterion, a message is presented to the user regarding the query potentially being slow to perform, and it is provided that the user can modify the query before the query is performed. A method to be performed in association with a data repository query includes receiving an input that specifies a query to be performed in a data repository. The query is performed in the data repository. If performance of the query exceeds a predefined limit, the query is recorded. Recorded queries may be used in improving system performance or in educating users.

### TECHNICAL FIELD

This description concerns methods that relate to performing data repository queries.

### BACKGROUND

Many computer systems include one or more data repositories where data is accumulated. Users may run queries on the repository data to extract interesting information, and the query results may be presented to the user in a graphical user interface (GUI). Different data repositories may include different amounts of data. For example, repositories in systems designated as Enterprise Resource Planning (ERP) or Customer Relations Management (CRM) can be very large. Many repositories are also indexed, which means that if the query includes a search term for an attribute or combination of attributes that is covered by an index (i.e., an indexed attribute/attribute combination), the index can help identify any occurrence of the term in the repository. In contrast, a query that does not have a value for any indexed attribute(s) may require a scan over a large number of entries in the repository, such as a full table scan, which can be very slow.

Performing a query may take a long time. There are several reasons why: the query does not include a search term for any of the indexed fields, or the query is otherwise too unspecific, to name just two examples. The size of the repository may also affect the time for searching. In some systems, the computer from which the user initiates the query is “locked” until the data repository system completes or otherwise terminates the query. This can be a disadvantage if query performance is slow.

In some existing systems, this problem is partially addressed by performing the query in several steps: first, the system determines the set of objects that is responsive to the query; and second, the system retrieves additional fields describing the object(s). If the system finds many objects in the first step, it can prompt the user about this through a popup window that is displayed before performing the second step. However, also performing the first step may take considerable time, for example if the repository is large. Also, not every repository may be configured to accept such two-step searching.

In other existing solutions, the system can automatically terminate the search upon finding a specified number (N) of hits. The N hits are then presented to the user as the query results. This approach is not useful for queries that require the entire repository to be inventoried, such as searches calling for “the 100 last orders” or “the 5 most valuable opportunities.” Moreover, also retrieving the N hits may take considerable time, for example if the query has no value for an indexed attribute. Finally, this approach is unsuitable if the desired information is spread over two or more data sources in the repository.

### SUMMARY

The invention relates to methods relating to data repository queries.

In a first general aspect, a method to be performed before performing a data repository query comprises receiving an input from a user, the input specifying a query to be performed in a data repository. Before performing the query, the method comprises determining whether the query meets a predefined criterion associated with slow data repository queries. If the query meets the predefined criterion, the method comprises presenting a message to the user regarding the query potentially being slow to perform, and providing that the user can modify the query before the query is performed.

In selected embodiments, the predefined criterion may be that the query is not sufficiently selective, that the query is equal to a previously performed slow query, or that the query matches a rule for identifying possibly slow queries. Such a rule may be formulated based on an observation made by a system administrator upon reviewing a search screen or a log of previously recorded slow queries.

The predefined criterion may be user-specific. The method may comprise blocking future performance of the query. The method may take into account whether the user has previously run slow queries.

In a second general aspect, a method to be performed in association with a data repository query comprises receiving an input that specifies a query to be performed in a data repository. The method comprises performing the query in the data repository and, if performance of the query exceeds a predefined limit, recording the query.

In selected embodiments, a record of one or more queries thus created can be forwarded to a system administrator or to a person who provides technical support to users of the repository, or be used in providing feedback to users.

Advantages of the systems and techniques described herein may include any or all of the following. Providing improved data repository querying; providing a more user-friendly query function; avoiding slow queries; providing query-related feedback to help the user or a system administrator; providing sharing of information about slow queries; and providing tracing of slow or otherwise resource-intensive queries.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

FIGS. 1A and 1B are examples of a GUI that can be used in initiating data repository queries;

FIG. 2 is a block diagram of an exemplary system in which data repository queries can be performed;

FIGS. 3 and 4 are flow charts of embodiments of inventive methods; and

FIG. 5 is a block diagram of a general computer system.

Like reference numerals in the various drawings indicate like elements.

### DETAILED DESCRIPTION

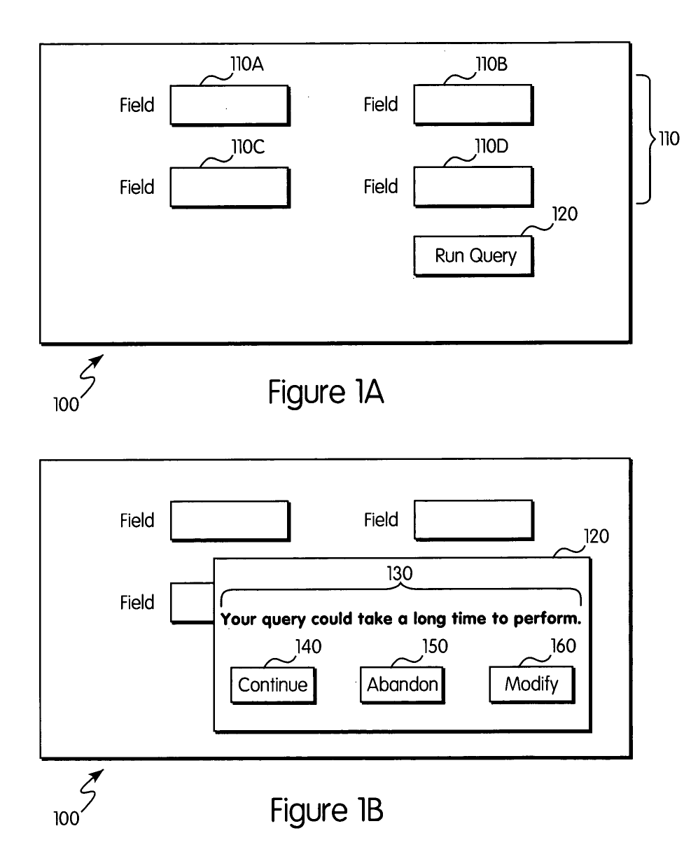

FIG. 1A shows a GUI that may be presented to a user in a computer system. For example, the user triggers the system to display the GUI 100 because the user wishes to initiate a query in a data repository of the system. The user may create the query by entering one or more terms (or values) for at least one field 110 that exists in the repository. Each field corresponds to at least one attribute that can be assigned to any or all records in the repository. Here, the GUI includes four fields 110A-D and the user can make an entry in any or all of the fields. The user initiates the query using a “Run Query” input control 120. Accordingly, the system receives an input from the user specifying the query to be performed in the data repository.

Before performing the query, the system determines whether the query meets a predefined criterion associated with slow data repository queries. Examples of such criteria will be described below. If the query meets the predefined criteria, the system may present a message to the user regarding the query potentially being slow to perform.

FIG. 1B shows an example of presenting such a message. Upon determining that the query meets the predefined criteria, the system may display a popup window 120 in the GUI 100. The window 120 includes a message 130 that in this example states: “Your query could take a long time to perform.” In other implementations, the message 130 may use different language to communicate the message that the specified query is potentially slow to perform. The popup window 120 includes respective Continue, Abandon and Modify input controls 140, 150 and 160. The user can select Continue to have the system perform the query as specified. The user can select Abandon if the user does not wish to run any query at the moment; this may result in the system ceasing to display the GUI 110 for now. The user can select Modify to return to the GUI 100 as shown in FIG. 1A; from there, the user can make any desired changes before initiating the modified query. Below will be described helpful messages that can be displayed to the user, for example upon the user selecting the Modify option.

In some implementations, the message 130 may also include other information, such as a suggested change that may make the query perform faster. For example, the fields 110A and 110B may correspond to indexed attributes (i.e., they are “indexed fields”). In contrast, the fields 110C and 110D may be non-indexed fields. If the user enters a value in the non-indexed fields but does not enter any value in the indexed fields, the query requires a full table scan in the repository. To alert the user of this situation, the message 130 may include an additional phrase such as “Entering a value in either of the fields 110A and 110B may speed up performance of the query.” Thus, the message may identify at least one indexed attribute to the user. Doing so may help the user to avoid being blocked by slow repository queries, and it may help avoid spending system resources on such queries.

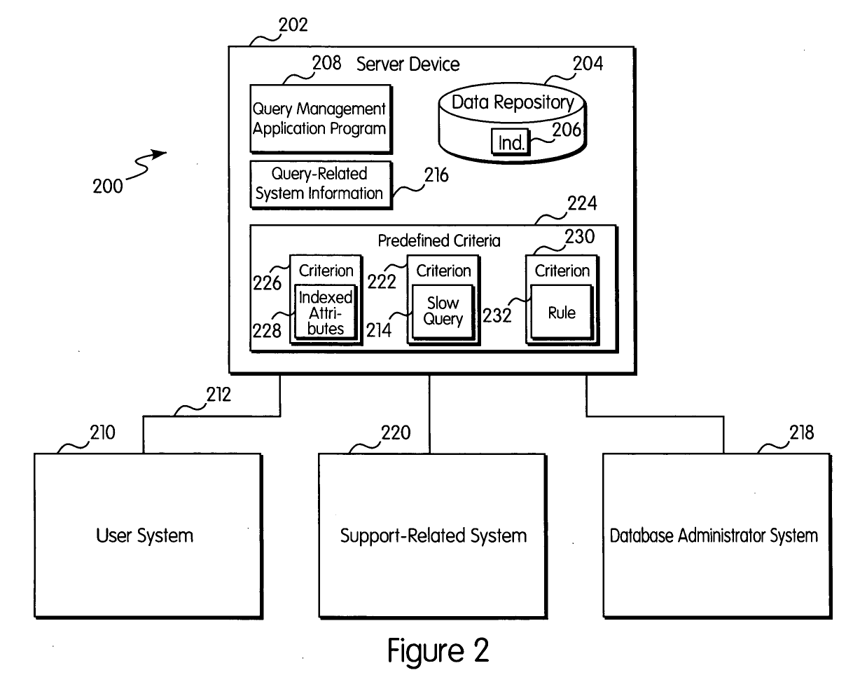

FIG. 2 is a block diagram of a computer system 200. For example, the system allows users to initiate repository queries and can generate the GUI 100 described above. The system includes a server device 202 that has access to a data repository 204 in which queries can be performed. The data repository may include one or more indices 206 for a specific repository table, for example a primary and a secondary index. Moreover, the system may include a query management application program (QMAP) 208 that includes instructions for performing queries in the repository 204, and for producing the GUI 100, to name just two examples.

Another system may be connected to the server device 202. For example, one or more user systems 210 may be configured such that their users can formulate and initiate repository queries through one or more connections 212. The user system 210 may be involved in the example above that relates to FIGS. 1A and 1B. For example, the user system may include a computer that has a network connection to the server device 202. Accordingly, the GUI 100 may be generated for display on the user's computer.

The system 200 may track queries that are performed and monitor whether their performance exceeds a predefined limit. For example, QMAP 208 may be configured to register whether any query exceeds one or more limits. Such limits may include a predefined time for performing the query, a limit for the amount of data that is responsive to the query, and a maximum number of hits for the query, to name just three examples. Combinations of these limits may be used. Limits may be different for different users or user groups. For example, the system may be designed to accept longer response times for queries from a service that runs in batch mode than for queries from individual users.

Accordingly, if the performance of the query exceeds the limit(s), the system may record the query in a slow query file 214. Such recording in the file 214 may also involve recording query-related system information 216. The following are examples of the information 216 that may then be recorded: Details of the query, such as the attribute(s) and corresponding value(s); information on the origin of the query, such as an identity of the user initiating the query, a name of a screen from which the query was initiated, an application program interface involved in initiating the query; context information, such as technical or application context information; and call stack information. Combinations of these examples of information 216 may be recorded. Instead of using the file 214, the query-related system information 216 may be stored in the repository or kept in memory for a longer time. This may allow aggregation of data and, as a result, only the aggregated data needs to be stored later, such as at system shutdown.

The system may permit different entities to initiate queries. For example, a user can enter a query using the GUI 100, or the server device 202 may receive a batch input query from another system connected thereto. The system may track queries received from any or all of such entities and, if warranted, record their respective query in the file 214.

The file 214 may be used for one or more purposes in the system 200. First, the file may be used in attempting to reduce the performance times for queries. The system 200 may include a database administrator system 218 connected to the server device 202. For example, the system 218 is a computer device used by a person who is a database administrator for the data repository 204, and who is responsible for maintaining the indices 206. Accordingly, the file 214 can be provided to the database administrator through the system 218. This informs that person about queries that take a long time to perform. That knowledge may in turn lead to any of 1) a decision to index additional attributes in the data repository (if there are particular unindexed attributes that the users often need to search for), 2) a decision to modify or extend existing indices, or 3) a decision to give the users more training in repository searching (if the slow queries indicate that users mistakenly formulate very extensive queries), to name just a few examples. The file 214 may contain other information relating to the query or to its performance, which may be useful in deciding whether any action should be taken. Another example of using information about previously performed slow queries is to block them from being performed. That is, upon a user specifying a blocked query, the system, recognizing it from the previous queries, will not perform it.

Second, the file 214 may be used in providing technical support to users of the system 200. A support-related system 220 may be connected to the server device 202. When users have problems with the data repository 204, for example that queries take too long to perform, they can contact a person that operates the support-related system 220. One or more queries that have been recorded as slow queries may be provided to the support person. The support person can compare the user's query with those in the file 214. If the query is listed there, it means that the query has already been identified as a slow query. Furthermore, the details of the recorded query can help the support person reconstruct cases where performance was poor. This knowledge is useful in helping the user overcome the problem, and it can also be helpful in enhancing the QMAP 208 and the design of data structures and indices in the repository in future releases of software used in the system 200.

Third, the file 214 may be used in providing feedback to users that are about to initiate queries, as described with reference to FIGS. 1A and 1B above. That is, the slow-query file 214 may be included in a first predefined criterion 222 accessible to the QMAP 208. Before performing a query received from a user, the server device may determine whether the user's query meets the first predefined criterion. This may involve performing a comparison to determine, for example, whether the user's query equals any query listed in the file 214. If there is a match, the GUI can present the message 130 to the user before the query is performed. The message can be tailored to the user. In some implementations, the message is presented only if the user has a history of running slow queries. That is, the system may let an isolated slow query be performed, but may present the message upon determining that the user has previously specified several slow queries.

The first predefined criterion 222 may be one of several predefined criteria 224 that the system 200 uses. A second predefined criterion 226 may relate to an indexing status of the data repository 204. For example, the second predefined criterion may include a file 228 listing attributes that are indexed in the repository. The file 228 may be generated using the one or more indices 206. Accordingly, the server device may determine, upon receiving a query from a user, whether the user's query includes a value for any attribute listed in the file 228, such as a value for any of a primary and a secondary index. The system may determine whether the query is sufficiently selective to avoid a lengthy response time. If the query is not selective enough, too many of the available records will be responsive to the query. For example, the following queries may have an unacceptable selectivity: a) queries that contain a wildcard for a certain attribute; b) queries that includes an indexed attribute value that is known to exist in most of the repository records; or c) queries that do include a value for an indexed attribute, but where the indexed attribute is at the end of the index and there are no values for the primary index attribute(s). Accordingly, the predefined criterion can include a predefined selectivity criterion. If any of these conditions are met, the GUI can present the message 130 to the user before the query is performed, optionally including content such as examples of indexed attributes or information on how to improve the query.

A third predefined criterion may relate to observations regarding the data repository made by a person who is knowledgeable about the repository. That is, system administrators and others sometimes can identify, based on their expert knowledge, what queries may take a long time to perform. The administrator's observation may be made upon reviewing a search screen including input fields for searching the data repository. As another example, the administrator may make the observation upon reviewing the file 214. The knowledgeable person's observation can be used to create one or more rules 232. The rule 232 may identify one or more particular queries, or specific aspects that characterize any such query. Thus, the server device may determine, upon receiving a user's query, whether the query meets the predefined criterion that comprises the one or more rules 232. Basing the rule on the administrator's observation may have the advantage that the rule can take into account also issues that are essentially unrelated to the technical implementation of the repository. For example, the administrator may observe that, due to the nature of the business that is being conducted using the system 200, almost all of the stored records may share the same value in a given attribute. Thus, the rule can be created such that it identifies queries that include only this attribute.

Any or all of the predefined criteria 224 may be used to determine whether to present the message to the user before performing the user's query. Here, for example, the message 130 may be presented upon receiving a user's query that meets at least one of the first, second and third predefined criteria. Here, the indexed-attributes file 228 and the rules 232 may be the results, ultimately, of specific system configuration settings, while the file 214 may be a log tracking the daily activities in the system. Accordingly, a wide variety of information sources may be used in formulating the predefined criteria. Other criteria may be used instead of, or in combination with, any of those described here.

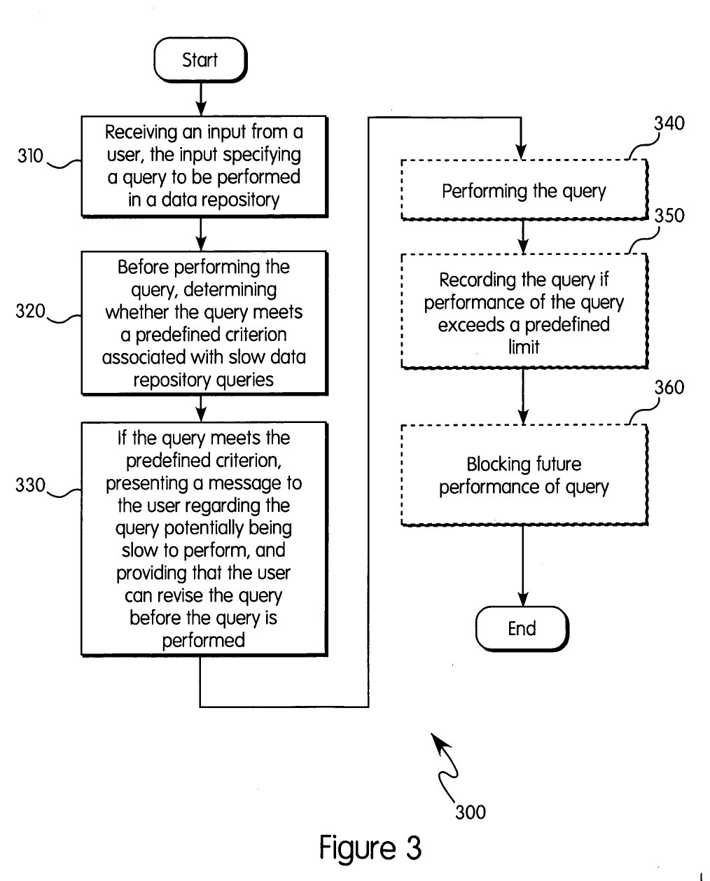

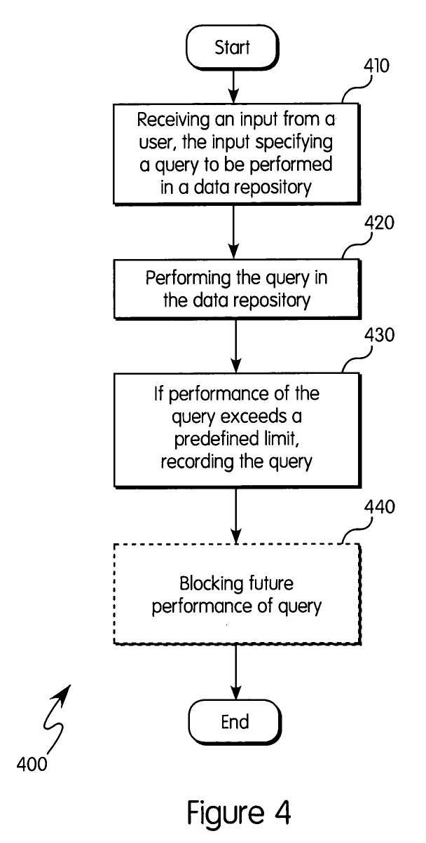

FIGS. 3 and 4 are embodiments of respective inventive methods 300 and 400. The methods 300 and 400 may be performed in the system 200. For example, a computer program product may include instructions that cause a processor to perform operations comprising the steps of any or both of the methods. As shown in FIG. 3, the method 300 includes the following steps:

Receiving, in step 310, an input from a user, the input specifying a query to be performed in a data repository. In the system 200, for example, the QMAP 208 in the server device 202 can receive an input from the user system 210 through the connection 212. The input may specify, using one or more of the fields 110, a query to be performed in the data repository 204.

Before performing the query, determining, in step 320, whether the query meets a predefined criterion associated with slow data repository queries. For example, the QMAP 208 may cause the server device 202 to determine whether the query meets one or more of the predefined criteria 224. For example, the criteria may relate to previously performed slow queries, an indexing status of the data repository 204, or observations regarding the data repository made by a knowledgeable person.

If the query meets the predefined criterion, presenting, in step 330, a message to the user regarding the query potentially being slow to perform, and providing that the user can modify the query before the query is performed. For example, the GUI 100 may present the message 130 to the user and provide that the user can choose between continuing, abandoning and modifying the query. The message 130 may propose a change in the query to make its performance faster.

Performing, in optional step 340, the query subsequent to presenting the message. The query may have been modified after the message was presented to the user.

Recording, in optional step 350, the query if performance of the query exceeds a predefined limit. For example, the QMAP 208 may include a time limit for performance, or a size limit for query results. The query may be recorded if the performance exceeds any or both of these limits. There may also be recorded information relating to an origin of the query or a current system status, to name just two examples.

Blocking future performance of the query in optional step 360. For example, the blocking may be a temporary measure while index improvements are being performed. Alternatively, the blocking may be for an indefinite period of time. Blocking particular queries that require substantial system resources may improve system performance, particularly in multi-user systems.

As shown in FIG. 4, the method 400 includes the following steps:

Receiving, in step 410, an input that specifies a query to be performed in a data repository. This step may be performed in accordance with step 310 described above. Optionally, and before performing the query, the server device may determine whether the query meets a predefined criterion associated with slow data repository queries and, if it does, present a message regarding this to the user, for example as described in steps 320 and 330 above.

Performing, in step 420, the query in the data repository. For example, the QMAP 208 may instruct the server device 202 to perform the user's query in the data repository 204. If the system optionally evaluated the criterion and presented the message, the user may have modified the query before it is performed in this step.

If performance of the query exceeds a predefined limit, recording the query in step 430. This step may be performed in accordance with optional step 350 described above.

Blocking, in optional step 440, future performance of the query. This step may be performed in accordance with optional step 360 described above.

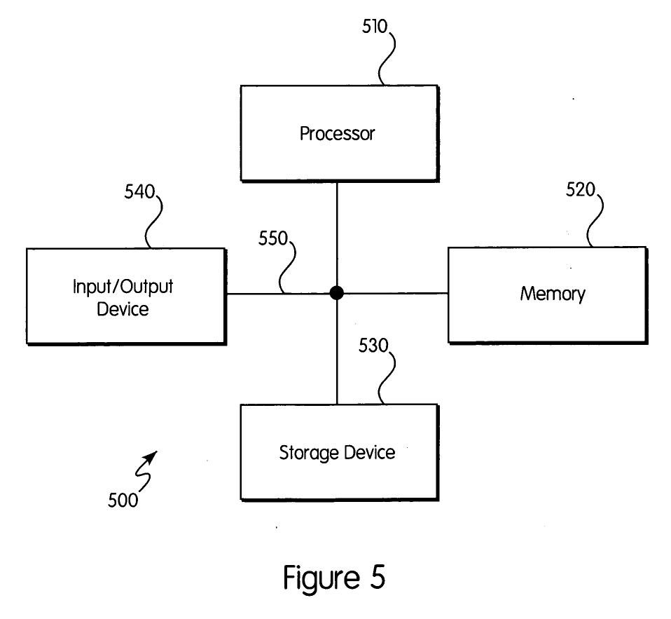

FIG. 5 is a block diagram of a computer system 500 that can be used in the operations described above, according to one embodiment. For example, the system 500 may be included in the system 200 or in any or all of the server device 202, user system 210, database administrator system 218 and support-related system 220.

The system 500 includes a processor 510, a memory 520, a storage device 530 and an input/output device 540. Each of the components 510, 520, 530 and 540 are interconnected using a system bus 550. The processor 510 is capable of processing instructions for execution within the system 500. In one embodiment, the processor 510 is a single-threaded processor. In another embodiment, the processor 510 is a multi-threaded processor. The processor 510 is capable of processing instructions stored in the memory 520 or on the storage device 530 to display graphical information for a user interface on the input/output device 540.

The memory 520 stores information within the system 500. In one embodiment, the memory 520 is a computer-readable medium. In one embodiment, the memory 520 is a volatile memory unit. In another embodiment, the memory 520 is a non-volatile memory unit.

The storage device 530 is capable of providing mass storage for the system 500. In one embodiment, the storage device 530 is a computer-readable medium. In various different embodiments, the storage device 530 may be a floppy disk device, a hard disk device, an optical disk device, or a tape device.

The input/output device 540 provides input/output operations for the system 500. In one embodiment, the input/output device 540 includes a keyboard and/or pointing device. In one embodiment, the input/output device 540 includes a display unit for displaying graphical user interfaces. For example, the input/output device can generate the GUI 100.

The invention can be implemented in digital electronic circuitry, or in computer hardware, firmware, software, or in combinations of them. Apparatus of the invention can be implemented in a computer program product tangibly embodied in an information carrier, e.g., in a machine-readable storage device or in a propagated signal, for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. A computer program is a set of instructions that can be used, directly or indirectly, in a computer to perform a certain activity or bring about a certain result. A computer program can be written in any form of programming language, including compiled or interpreted languages, and it can be deployed in any form, including as a stand-alone program or as a module, component, subroutine, or other unit suitable for use in a computing environment.

Suitable processors for the execution of a program of instructions include, by way of example, both general and special purpose microprocessors, and the sole processor or one of multiple processors of any kind of computer. Generally, a processor will receive instructions and data from a read-only memory or a random access memory or both. The essential elements of a computer are a processor for executing instructions and one or more memories for storing instructions and data. Generally, a computer will also include, or be operatively coupled to communicate with, one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM and DVD-ROM disks. The processor and the memory can be supplemented by, or incorporated in, ASICs (application-specific integrated circuits).

To provide for interaction with a user, the invention can be implemented on a computer having a display device such as a CRT (cathode ray tube) or LCD (liquid crystal display) monitor for displaying information to the user and a keyboard and a pointing device such as a mouse or a trackball by which the user can provide input to the computer.

The invention can be implemented in a computer system that includes a back-end component, such as a data server, or that includes a middleware component, such as an application server or an Internet server, or that includes a front-end component, such as a client computer having a graphical user interface or an Internet browser, or any combination of them. The components of the system can be connected by any form or medium of digital data communication such as a communication network. Examples of communication networks include, e.g., a LAN, a WAN, and the computers and networks forming the Internet.

The computer system can include clients and servers. A client and server are generally remote from each other and typically interact through a network, such as the described one. The relationship of client and server arises by virtue of computer programs running on the respective computers and having a client-server relationship to each other.

A number of embodiments of the invention have been described. Nevertheless, it will be understood that various modifications may be made without departing from the spirit and scope of the invention. Accordingly, other embodiments are within the scope of the following claims.

What is claimed is:

1. A method to be performed before performing a data repository query, the method comprising:
receiving an input from a user, the input specifying a query to be performed in a data repository;
before performing the query, determining whether the query meets a predefined criterion associated with slow data repository queries; and
if the query meets the predefined criterion, presenting a message to the user regarding the query potentially being slow to perform, and providing that the user can modify the query before the query is performed.

2. The method of claim 1, wherein the predefined criterion is a threshold for an expected selectivity of the query.

3. The method of claim 1, wherein the data repository is indexed in relation to at least one index attribute, and wherein the predefined criterion is that the query does not include a term for the at least one index attribute.

4. The method of claim 3, wherein the message identifies the at least one index attribute to the user.

5. The method of claim 1, wherein the predefined criterion is that the query is equal to a previously performed slow query.

6. The method of claim 5, wherein the previously performed slow query was recorded upon determining that performance of the previously performed slow query exceeded a limit selected from the group consisting of: a predefined time for the performance, a predefined amount for data responsive to the query, a maximum number of query hits, and combinations thereof.

7. The method of claim 1, wherein the predefined criterion is user-specific.

8. The method of claim 1, wherein the predefined criterion is that the query matches a rule for identifying possibly slow queries, the rule being created using an observation made by a person who is knowledgeable about the data repository.

9. The method of claim 8, wherein the person makes the observation upon reviewing a search screen including input fields for searching the data repository.

10. The method of claim 8, wherein the person makes the observation upon reviewing a record of previously performed slow queries.

11. The method of claim 1, wherein there are several predefined criteria associated with slow data repository queries.

12. The method of claim 1, further comprising performing the query subsequent to presenting the message.

13. The method of claim 12, further comprising recording the query if performance of the query exceeds a predefined limit.

14. The method of claim 13, wherein the predefined limit is selected from the group consisting of: a predefined time for the performance, a predefined amount for data responsive to the query, a maximum number of hits for the query, and combinations thereof.

15. The method of claim 13, wherein the user modifies the query before the query is performed.

16. The method of claim 1, wherein the message is presented to the user upon determining that the user has previously specified several slow queries.

17. A computer program product tangibly embodied in an information carrier, the computer program product including instructions that, when executed, cause a processor to perform operations comprising:
receive an input from a user, the input specifying a query to be performed in a data repository;
before performing the query, determine whether the query meets a predefined criterion associated with slow data repository queries; and
if the query meets the predefined criterion, present a message to the user regarding the query potentially being slow to perform, and providing that the user can modify the query before the query is performed.

18. A method to be performed in association with a data repository query, the method comprising:
receiving an input that specifies a query to be performed in a data repository;
performing the query in the data repository; and
if performance of the query exceeds a predefined limit, recording the query.

19. The method of claim 18, wherein the predefined limit is selected from the group consisting of: a predefined time for the performance, a predefined amount for data responsive to the query, a maximum number of hits for the query, and combinations thereof.

20. The method of claim 18, wherein the predefined limit is user-specific.

21. The method of claim 18, wherein recording the query further comprises making the query available to a person that provides technical support relating to the data repository.

22. The method of claim 18, wherein recording the query further comprises making the query available to a database administrator for the data repository.

23. The method of claim 18, wherein recording the query further comprises making the query available for comparison with at least one new query to be performed on the data repository.

24. The method of claim 23, wherein the at least one new query equals the query, further comprising presenting a message and providing that the at least one new query can be modified before being performed.

25. The method of claim 18, wherein the input is one selected from the group consisting of: a user input, a batch input, and combinations thereof.

26. The method of claim 18, wherein information recorded upon the performance of the query exceeding the predefined limit is selected from the group consisting of: query details, a query origin, an identity of a user initiating the query, a name of a screen from which the query was initiated, an application program interface involved in initiating the query, call stack information, context information, and combinations thereof.

27. The method of claim 18, further comprising blocking a future performance of the query.

28. A computer program product tangibly embodied in an information carrier, the computer program product including instructions that, when executed, cause a processor to perform operations comprising:
receive an input that specifies a query to be performed in a data repository;
perform the query in the data repository; and
if performance of the query exceeds a predefined criterion, record the query.
